(19) United States
(12) Patent Application Publication
(10) Pub. No.: US 2019/0354734 A1
(43) Pub. Date: Nov. 21, 2019

(54) COMBINED RADIO FREQUENCY IDENTIFICATION TAG AND BLUETOOTH LOW ENERGY BEACON

(71) Applicant: Avery Dennison Retail Information Services LLC, Mentor, OH (US)

(72) Inventor: Ian J. Forster, Chelmsford (GB)

(21) Appl. No.: 16/415,525

(22) Filed: May 17, 2019

Related U.S. Application Data
(60) Provisional application No. 62/673,393, filed on May 18, 2018.

(51) Int. Cl. G06K 7/10; G06K 19/077

(52) U.S. Cl. CPC G06K 7/10158; G06K 19/07773

(57) ABSTRACT

A transponder includes a radio frequency identification (RFID) tag and a Bluetooth low energy (Bluetooth LE) beacon communicatively connected using an inter-integrated circuit (I²C) link. The Bluetooth LE beacon sends data such as battery status, temperature, or sensor data to the RFID tag which is retrieved by an RFID reader system. The RFID reader system sends updated messages, message repetition rate, and power data to the RFID tag to change the operating mode of the Bluetooth LE beacon. The RFID reader system selects the RFID tag which asserts a wakeup signal, or provides power to the Bluetooth LE beacon to start sending beacon messages. The RFID tag operates in a power-assist mode when receiving power from the Bluetooth LE beacon. The Bluetooth LE beacon increases the transmission power level when the RFID tag provides power to the Bluetooth LE beacon. The transponder can include a dual band UHF and ISM antenna.

### CROSS REFERENCE TO RELATED APPLICATION(S)

The present application claims priority to and the benefit of United States provisional patent application number 62/673,393 filed May 18, 2018, which is incorporated herein by reference in its entirety.

### TECHNICAL FIELD

The subject application generally relates to combined radio frequency identification (“RFID”) tags and Bluetooth Low Energy (“Bluetooth LE”) beacons and, more specifically, to an RFID tag configured to exchange data, power, and signaling with a Bluetooth LE beacon.

### BACKGROUND

Various industries pack, ship, and present for sale items for consumers. Example items include garments, electronic devices, and so forth. Items are typically manufactured in a manufacturing facility, after which the items are packed and shipped by truck or other means to warehouses or directly to stores. Inventory control at each stage, from manufacturer to warehouse, to store, can be accomplished by a suitable RFID system using RFID tags that are attached to the items for sale.

Radio Frequency Identification (“RFID”) systems can operate at ultra-high frequency (“UHF”), including at frequencies such as between 860 MHz to 960 MHz. RFID transponders, such as RFID tags, typically include an antenna and/or tuning loop coupled to an RFID chip. The RFID chip receives power when excited by a nearby electromagnetic field oscillating at the resonant frequency of the RFID transponder, such as when an RFID reader interrogates the RFID tag. Once the RFID chip has received sufficient power, (e.g., such as 10 μW), the RFID chip turns on and sends a coded return signal via the antenna or tuning loop. An RFID reader interrogating the RFID tag receives and decodes the coded return signal from the RFID transponder.

Because RFID tags are typically passively powered, meaning such tags do not contain a power source and only transmit a signal upon receiving RF energy emitted from a reader in proximity to the tag, transmission range is typically limited to between 1 meter and 10 meters depending on the RFID reader and RFID tag hardware. RFID tags are capable of both receive and transmit functions, may contain non-volatile memory, and are lower cost than other solutions, such as Bluetooth Low Energy (“Bluetooth LE”) beacons. However, the ability to interrogate RFID tags is not common in mobile phones.

Bluetooth LE beacons, transmit data-carrying messages of a given length at defined intervals. Bluetooth LE beacons are generally battery powered and actively transmit in the 2.45 Ghz Industrial Scientific and Medical (“ISM”) band. Because Bluetooth LE beacons are battery powered, typical ranges can be tens of meters. Many mobile phones can receive Bluetooth LE beacon messages if within the range of the Bluetooth LE beacon. However, in the lowest cost and lowest power consumption implementations, Bluetooth LE beacons do not have a receive capability, and therefore cannot be updated wirelessly.

Accordingly, what is needed is a transponder having advantageous features associated with each of RFID tags and Bluetooth LE beacons, without the attendant disadvantages.

### SUMMARIES

According to certain embodiments, a transponder includes a radio frequency identification (RFID) circuit and a Bluetooth low energy (“Bluetooth LE”) beacon circuit. The RFID circuit and Bluetooth LE beacon circuit are communicatively connected, for example using an inter-integrated circuit (“I²C”) link. The Bluetooth LE beacon circuit can be configured to transmit data such as battery status, temperature, or sensor data to the RFID circuit, which sends the data to an RFID reader system when interrogated. The RFID circuit can be configured to transmit data to the Bluetooth LE beacon circuit, which updates one or more operating parameters based on the data. For example, the RFID circuit can be configured to transmit data such as but not limited to the message to be transmitted as the beacon message, the message repetition rate, or the output power for transmitting the beacon message to the Bluetooth LE beacon circuit. The transponder can include a dual band UHF and ISM antenna.

The RFID circuit can be configured to provide power to the Bluetooth LE beacon circuit when the RFID circuit is excited by a nearby electromagnetic field. When the RFID circuit is selected by the RFID reader system, the RFID circuit can send a wakeup signal or power to the RFID circuit. The Bluetooth LE circuit may include a battery. The RFID circuit can send power to the Bluetooth LE circuit to charge the battery or transmit at a higher power and achieve greater range. Transmit power settings may vary and have multiple ranges. The ranges may be categorized as low power, medium power, and high power. The ranges may additionally have multiple categories other than the three mentioned. Examples of different transmit power settings could be: low power/short range, for example 15 m, at −14 dBm; medium power/medium range, for example 30 m at −8 dBm; and high power/long range, for example 75 m at 0 dBm.

The Bluetooth LE circuit can send power from the battery to the RFID circuit to allow the RFID circuit to operate in a battery-assisted power mode. In one embodiment the mode may be activated by the beacon controller at a number of intervals. For example, the beacon may wake up from a sleep-like mode to transmit a message. In another example, the mode may be activated at an interval either pre-programmed into the beacon controller and/or set via the RFID circuit. In another embodiment, the mode can be activated dependent on external factors such as but not limited to the light level in a store, such as a retail store, indicating for example that it is closed. The various embodiments relating to the activation of different modes may be incorporated within the same transponder device. In other certain embodiments, a combined RFID tag and Bluetooth LE beacon includes an RFID tag that has an I²C interface and a Bluetooth LE beacon that has an I²C interface and battery. The RFID tag and Bluetooth LE beacon communicate data via the I²C interfaces. The data can include battery status, temperature, or other sensor data. For example, sensor data can include the response from a passive infrared sensor determining the presence of a consumer by the interruption of light from the store lighting system, indicating a consumer is present and interacting with the product from a sensor that is monitored by the Bluetooth LE beacon. The beacon may record the status of a sensor into the RFID device memory when the beacon is transmitting. For example, in the case of a sensor capable of determining that a consumer is present, every time the beacon transmits, a bit will either be set or not set. Upon further analysis, there may be a derivation of the time from the known interval of transmission from the beacon since activation and any adaptation from any change in transmission interval, which may then be used to correlate events where a transmission occurred when a consumer was present with sales of products in that location, providing analytical data about the effectiveness of the beacon on encouraging sales.

The RFID tag can receive the data from the Bluetooth LE beacon and send the data to the RFID reader system when interrogated by an RFID reader system. The data can include an update, a message, a message repetition rate, and a beacon output power parameter. The data can be received by the RFID tag from the RFID reader system and sent to the Bluetooth LE beacon. The Bluetooth LE beacon can change operation in response to receiving the data.

The RFID tag can assert a wakeup signal across a control line to the Bluetooth LE beacon. The RFID tag and Bluetooth LE beacon can transfer power across a power line. The RFID tag and Bluetooth LE beacon can change operational mode in response to power being transferred. The operational mode can include operating the RFID tag in a power-assisted mode using power from the battery, charging the battery from power received by the RFID tag, operating the Bluetooth LE beacon using power received by the RFID tag, or operating the Bluetooth LE beacon at a higher transmission power using power from the battery and the RFID tag. The operational mode may also include: transferring data from the RFID device to the beacon controller in either real time or at intervals; transferring data from the beacon controller to the RFID tag; placing the beacon transmission under direct command from the RFID tag and hence the associated RFID reader; and using the direct command mode to allow the infrastructure to trigger the beacon transmission in relation to sensed information that the infrastructure contains. For example, sensed information may include but is not limited to the number of Wi-Fi connected devices in an area, the number of people from a camera system, the presence of a staff member, or changing the beacon transmission using the RFID tag interface to a specific sequence to improve the performance of location functions.

In further view of a specific sequence, one example may be a direct sequence spread spectrum emission, locking the beacon clock frequency to a frequency delivered from the infrastructure reader to allow measurements of phase. One embodiment of a specific sequence may be the following: location by receiving the beacon transmission; direct control on the edges of the data sequence sent to the beacon from the RFID tag to allowing measurement of the time of flight from the beacon to an infrastructure capable of detecting it; controlling emissions of the Bluetooth beacon so that it may be located with a phased array antenna system that may be co-located with a phased array reader system for the RFID tags; and using the RFID system to control the message repetition interval and/or also the start time. This will allow a number of beacons to operate in proximity of one another with lower risk of transmission collision in the time domain, muting the transmission of a short interval beacon transmitter at the time a known long interval higher power beacon will be transmitting.

According to yet other embodiments, a method includes interrogating an RFID tag that is coupled to a Bluetooth LE beacon by one or more control links, power lines, or data links, and updating an operational mode of the Bluetooth LE beacon in response to the RFID tag being interrogated by an RFID reader system. The operational mode can include waking the Bluetooth LE beacon from a sleep mode when a wakeup signal is asserted across a control line by the RFID tag. The operational mode can include transmitting an updated beacon message transmitted to the Bluetooth LE beacon across a data link by the RFID tag, which receives the updated beacon message from the RFID reader system. The operational mode can include transmitting the beacon message at an updated message repetition rate or at an increased power output level. The operational mode can include sending power across a power line for operating the RFID tag in a power-assisted mode using power from the battery associated with the Bluetooth LE beacon, operating the Bluetooth LE beacon using power from the RFID tag, or operating the Bluetooth LE beacon at a higher transmission level using power from the battery and the RFID tag. The method can include transmitting data from the Bluetooth LE beacon to the RFID tag and transmitting the data from the RFID tag to the RFID reader system in response to being interrogated. The data can include but is not limited to battery status, temperature, or sensor data.

### BRIEF DESCRIPTION OF THE DRAWINGS

FIG. 1 depicts a diagram of an example Bluetooth low energy (Bluetooth LE) beacon and associated transmission waveform according to an embodiment of the disclosure.

FIG. 2 depicts a diagram of an example interlinked radio frequency identification (RFID) and Bluetooth LE beacon device according to an embodiment of the disclosure.

FIG. 3 depicts a diagram of an example battery-assisted RFID Bluetooth LE device according to an embodiment of the disclosure.

FIG. 4 depicts a diagram of an example dual-band antenna RFID Bluetooth LE device according to an embodiment of the disclosure.

FIG. 5 depicts a diagram of an example RFID-powered Bluetooth LE device according to an embodiment of the disclosure.

### DETAILED DESCRIPTION

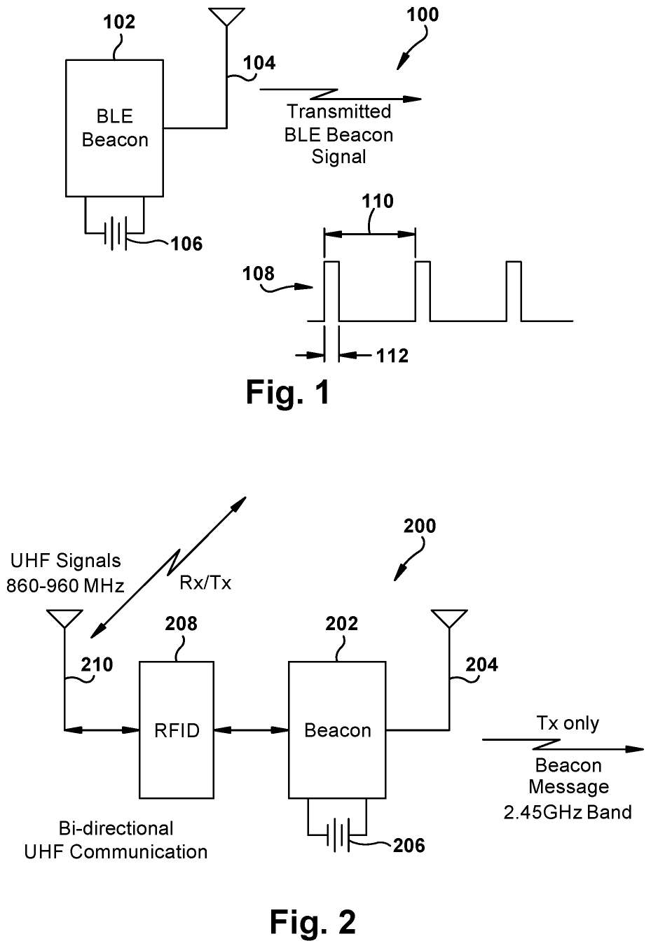

The systems and methods disclosed herein are described in detail by way of examples and with reference to FIGS. 1 to 5. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The systems and methods disclosed herein describe various methods of coupling RFID tags and Bluetooth LE beacons and transponders made therefrom. The present disclosure illustrates new modalities obtained when RFID tags and Bluetooth LE Energy beacons are communicatively and electrically coupled. Other RFID controlled functions may be associated with the beacon unit; in particular, providing a visual indicator using the battery energy present for the beacon transmission. Additionally, an audio emission may be associated with the beacon unit along with the visual indicator. However, one embodiment may include just an audio emission associated with the beacon unit if desired. Input functions associated with the RFID capability to pass data to the infrastructure may also include the status of a switch indicating that a consumer requires help or the level of stock associated with a weight sensor. Although the systems and methods described herein are particularly applicable to RFID and Bluetooth LE beacon systems and transponders, the structures and methodologies can be adapted for use with other types of wireless tags, for example those used in Electronic Article Surveillance (“EAS”) systems.

Referring now to FIG. 1, an example Bluetooth LE beacon 100 is presented. The Bluetooth LE chip 102 is electrically connected to an antenna 104 and a battery 106. The Bluetooth LE beacon 100 transmits data, illustrated schematically by waveform 108, at specified intervals 110. The interval 110 between messages can be regularly spaced or irregularly spaced. For example, the Bluetooth LE beacon 100 can be configured to transmit based on a trigger, such as a monitored sensor value. The interval 110 can be randomized with an average repetition rate. As can be appreciated, each transmission consumes a small amount of current for the duration 112 of the transmission, typically expressed in Coulombs (C). The capacity of battery 106 is also typically expressed in Coulombs. For example, a 20 mAh battery contains 72 Coulombs of charge. Assuming that the output voltage of battery 106 remains largely constant over the operational lifetime of the battery 106, the approximate number of total transmissions can be calculated. For example, if each transmission requires 1 mA of current for a duration 112 of 0.1 seconds, then each transmission consumes 0.1 mC of charge from the battery 106. A 20 mAh battery 106 would be able to send roughly 720,000 transmissions before being depleted. If the interval 110 between each transmission of data 108 averages 1 second, then battery 106 can power the Bluetooth LE beacon 100 for approximately 200 hours, or roughly 8.3 days.

Typically, changing a battery 106, adjusting the message or message repetition rate or interval 110, or increasing or decreasing power output requires a user to physically access the Bluetooth LE beacon 100. It would be advantageous to be able to adjust various parameters of the Bluetooth LE beacon 100 in response to an environmental factor, such as time or the volume of shoppers present in a store without substantially adding to the cost of the Bluetooth LE beacon 100.

In one embodiment, the monitoring of sensor values may be executed by an external device or smart device capable of pushing data, such as a computer, smart phone, tablet, gaming device or smart watch. The external device may push data, such as sensor information or consumer interaction (through the analysis, monitoring, and/or execution of pushing a virtual button), up via Wi-Fi. The store system may then transmit down the beacon via the RFID, interface and adapt the beacon transmission, providing a form of bi-directional communication between the smart device and system. For example, one systematic flow may be a smart device via Wi-Fi to host, host to beacon via RFID, beacon to smart device. For additional clarity, the consumer may push a button and receive confirmation of receipt of the input in a message transmitted by the beacon. The effective bi-directional communications show that the consumer is in proximity to a specific beacon.

Referring to FIG. 2, an interlinked RFID Bluetooth LE device 200 is presented. The interlinked RFID Bluetooth LE device 200 includes a Bluetooth LE beacon 202, which is connected to a first antenna 204 and battery 206, and an RFID chip 208, which is connected to a second antenna 210. Both the RFID chip 208 and Bluetooth LE beacon 202 are electrical circuits and can be packaged together or can be formed as distinct circuits as would be understood in the art. In another embodiment the RFID function and Bluetooth LE beacon function may be incorporated into a single device, with communication between function internal to the device. For example, the RFID chip 208 can be communicatively connected to the Bluetooth LE beacon 202 using an inter-integrated circuit (“I²C”) connection or link. The Bluetooth LE beacon 202 can be updated by the RFID chip 208, for example, over the I²C connection.

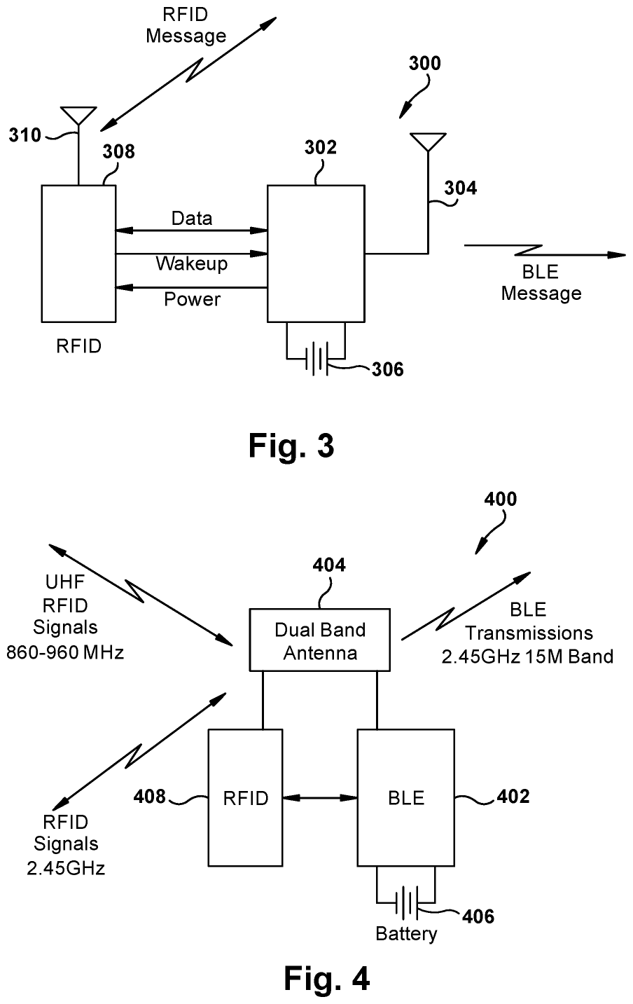

In operation, an RFID reader system (not illustrated) interrogates the RFID chip 208 of the interlinked RFID Bluetooth LE device 200. Example RFID reader systems can include warehouse RFID reader systems, ceiling-based RFID reader systems typical of retail outlets, or handheld RFID readers used by shop staff to carry out inventory operations and locate items tagged with RFID tags. In an embodiment, the RFID reader system can be “always on”, as is typical for ceiling-based RFID reader systems. When an RFID identity associated with the interlinked RFID Bluetooth LE device 200 is seen by the RFID reader system, an associated database can be queried to determine if any additional actions should be taken with the interlinked RFID Bluetooth LE device 200. For example, the interlinked RFID Bluetooth LE device 200 can be selected for an update or a control operation, such as changing the message, the message repetition rate, or the output power of the Bluetooth LE beacon 202. The RFID reader system can send the updated operating parameters to the RFID chip 208, and the RFID chip 208 can transmit the updated operating parameters to the Bluetooth LE beacon 202 over the I²C connection. In certain embodiments, data from the Bluetooth LE beacon 202 can also be written to the RFID chip 208 for retrieval by the RFID reader system. Example data can include the battery status, or sensor data. For example, if the Bluetooth LE beacon 202 is configured to monitor sensor data such as temperature, that sensor data can be transmitted over the I²C connection to the RFID chip 208 and can then read by the RFID reader system when the RFID chip 208 is interrogated. Referring to FIG. 3, a battery-assisted RFID Bluetooth LE device 300 is presented. The battery-assisted RFID Bluetooth LE device 300 includes a Bluetooth LE beacon 302, which is connected to a first antenna 304 and battery 306, and an RFID chip 308, which is connected to a second antenna 310. The RFID chip 308 is communicatively connected to the Bluetooth LE beacon 302, for example using an I²C connection, a serial peripheral interface (SPI) connection, or other suitable communication means for transmitting and receiving data.

The battery-assisted RFID Bluetooth LE device 300 may also include one or more signal connections, such as a wakeup line that the RFID chip 308 can assert to bring the Bluetooth LE beacon 302 out of a low power sleep mode. The wakeup line may be based on a specific predetermined RF power being received by the RFID chip 308 without data modulation. The wakeup line may also detect and integrate at any frequency and does not have to be UHF only, if the antenna has multi-frequency capabilities. The wakeup line may also detect and integrate when the RFID chip 308 has enough power to operate and receives a command telling it to wake up the RFID device. The Bluetooth LE beacon 302 can selectively provide power across a battery line to the RFID chip 308 allowing the RFID chip 308 to operate in a battery-assist mode. The Bluetooth LE beacon 302 can provide some, or all, of the power for the RFID chip 308. In this embodiment, the range that the RFID chip 308 can communicate with a reader system is substantially increased, as delivery of power from the reader system to the RFID chip 308 is generally the range-limiting factor. Depending upon the configuration of the RFID chip 308, the range can be increased by a factor of approximately four times the unassisted range. In an embodiment, the RFID chip 308 operates with very low power, on the order of 1 uA to 10 uA, and the power can be provided substantially continuously to the RFID chip 308.

Referring to FIG. 4, a dual-band antenna RFID Bluetooth LE device 400 is presented. The dual-band antenna RFID Bluetooth LE device 400 includes a Bluetooth LE beacon 402, a battery 406, and an RFID chip 408. The Bluetooth LE beacon 402 and the RFID chip 408 are both independently connected to a dual-band antenna 404. The RFID chip 408 is communicatively connected to the Bluetooth LE beacon 402, for example, using an I²C connection for transmitting and receiving data. In this embodiment, the dual-band antenna 404 permits the RFID chip 408 to operate in the UHF band or the ISM band.

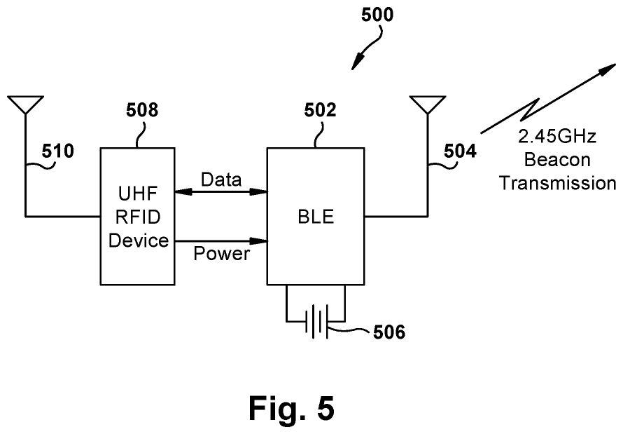

Referring to FIG. 5, an RFID powered Bluetooth LE device 500 is presented. The RFID powered Bluetooth LE device 500 includes a Bluetooth LE beacon 502, which is connected to a first antenna 504 and battery 506, and an RFID chip 508, which is connected to a second antenna 510. The RFID chip 508 is communicatively connected to the Bluetooth LE beacon 502, for example, using an I²C connection for transmitting and receiving data. The RFID chip 508 can provide power to the Bluetooth LE beacon 502 across a power line. In a first operational mode, the RFID chip 508 can charge the battery 506 of the Bluetooth LE beacon 502. In a second operational mode, the RFID chip 508 can provide power to the Bluetooth LE beacon 502 when the RFID chip 508 is selected by the RFID reader system (not illustrated). In a third operational mode, the RFID chip 508 can provide power to the Bluetooth LE beacon 502 when the battery 506 is exhausted. In a fourth operational mode, the RFID chip 508 can provide additional power to the Bluetooth LE beacon 502 in addition to the battery 506, permitting the Bluetooth LE beacon 502 to transmit at a higher power when an RFID signal from an RFID reader system is present.

The values disclosed herein are not to be understood as being strictly limited to the exact numerical values recited. Instead, unless otherwise specified, each such dimension is intended to mean both the recited value and a functionally equivalent range surrounding that value. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A transponder, comprising:
a radio frequency identification (RFID) circuit; and
a Bluetooth low energy (Bluetooth LE) beacon circuit communicatively connected to the RFID circuit.

2. The transponder of claim 1, wherein the RFID circuit and Bluetooth LE beacon circuit are communicatively connected across an inter-integrated circuit (I²C) link.

3. The transponder of claim 1, wherein the Bluetooth LE beacon circuit is configured to transmit data to the RFID circuit, and wherein the RFID circuit is configured to send the data to an RFID reader system when the RFID reader system interrogates the RFID circuit.

4. The transponder of claim 3, wherein the data includes one or more of battery status, temperature, or sensor data monitored by the Bluetooth LE beacon circuit.

5. The transponder of claim 1, wherein the RFID circuit is configured to transmit data to the Bluetooth LE beacon circuit, and the Bluetooth LE beacon circuit is configured to update one or more operating parameters based on the received data.

6. The transponder of claim 5, wherein the data includes one or more of a message to be transmitted by the Bluetooth LE beacon circuit, a message repetition rate, or an output power setting of the Bluetooth LE beacon circuit.

7. The transponder of claim 1, further comprising:
a dual band antenna communicatively connected to the RFID circuit and the Bluetooth LE beacon circuit,
wherein a first band of the dual band antenna is an ultra-high frequency (UHF) band, and
wherein a second band of the dual band antenna is an Industrial Scientific and Medical (ISM) band.

8. The transponder of claim 1, wherein the RFID circuit is configured to provide power to the Bluetooth LE beacon circuit when the RFID circuit is excited by an electromagnetic field, and wherein the Bluetooth LE beacon circuit is configured to power on and send one or more beacon messages when the Bluetooth LE beacon circuit receives power from the RFID circuit.

9. The transponder of claim 1, wherein the RFID circuit is configured to send one or more of a wakeup signal or power to the Bluetooth LE beacon circuit in response to the RFID circuit being selected by an RFID reader system, and wherein the Bluetooth LE beacon circuit is configured to transmit one or more beacon messages in response to receiving the wakeup signal or power.

10. The transponder of claim 1, further comprising:
a battery electrically connected to the Bluetooth LE beacon circuit.

11. The transponder of claim 10, wherein the RFID circuit is configured to send power to the Bluetooth LE beacon circuit and wherein the Bluetooth LE beacon circuit is configured to charge the battery and/or transmit beacon messages at a higher power.

12. The transponder of claim 11, wherein the Bluetooth LE beacon circuit is configured to selectively provide power from the battery to the RFID circuit, and wherein the RFID circuit is configured to operate in a battery-assisted power mode when power is provided by the Bluetooth LE beacon circuit.

13. A combined RFID tag and Bluetooth LE beacon, comprising:
an RFID tag that includes a first I²C interface; and
a Bluetooth LE beacon that includes a second I²C interface and a battery,
wherein the RFID tag and the Bluetooth LE beacon are configured to communicate data via the first I²C interface and the second I²C interface.

14. The combined RFID tag and Bluetooth LE beacon of claim 13, wherein the data includes one or more of battery status, temperature, or sensor data monitored by the Bluetooth LE beacon circuit, and wherein the RFID tag is configured to send the data to an RFID reader system when the RFID reader system interrogates the RFID tag.

15. The combined RFID tag and Bluetooth LE beacon of claim 13, wherein the data is received by the RFID tag from an RFID reader system and the data includes one or more of an update, a message, a message repetition rate, or a beacon output power parameter, and wherein the Bluetooth LE beacon is configured to change operation in response to receiving the data.

16. The combined RFID tag and Bluetooth LE beacon of claim 13, further comprising:
one or more of:
a control line for asserting a wakeup signal from the RFID tag to the Bluetooth LE beacon, or
a power line for transferring power between the RFID tag and the Bluetooth LE beacon for changing an operational mode of the combined RFID tag and Bluetooth LE beacon,
wherein the operational mode is selected from the group consisting of:
operating the RFID tag in a power-assisted mode using power from the battery,
charging the battery from power received by the RFID tag when the RFID tag is excited by an electromagnetic field,
operating the Bluetooth LE beacon using power received by the RFID tag when the RFID tag is excited by an electromagnetic field, and
operating the Bluetooth LE beacon at a higher transmission power using power from the battery and power received from the RFID tag when the RFID tag is excited by an electromagnetic field.

17. A method, comprising:
interrogating, by an RFID reader system, an RFID tag that is coupled to a Bluetooth LE beacon via one or more of a control line, a power line, or a data link; and
updating an operational mode of the Bluetooth LE beacon in response to the interrogating of the RFID tag.

18. The method of claim 17, wherein the operational mode is selected from the group consisting of:
waking, by the Bluetooth LE beacon, from a sleep mode in response to receiving a wakeup signal from the RFID tag across the control line,
transmitting, by the Bluetooth LE beacon, an updated beacon message received from the RFID reader system by the RFID tag and communicated to the Bluetooth LE beacon across the data link,
transmitting, by the Bluetooth LE beacon, the beacon message at an updated message repetition rate based on a parameter received from the RFID reader system by the RFID tag and communicated to the Bluetooth LE beacon across the data link,
transmitting, by the Bluetooth LE beacon, the beacon message at an increased power output level based on a parameter received from the RFID reader system by the RFID tag and communicated to the Bluetooth LE beacon across the data link,
sending power, across the power line, from a battery associated with the Bluetooth LE beacon to the RFID tag for operating the RFID tag in a power-assisted mode,
charging the battery, across the power line, from power received by the RFID tag while the RFID tag is interrogated by the RFID reader system,
operating the Bluetooth LE beacon using power received, across the power line, by the RFID tag while the RFID tag is interrogated by the RFID reader system, and
operating the Bluetooth LE beacon at a higher transmission level using power from the battery and power received, across the power line, from the RFID tag while the RFID tag is interrogated by the RFID reader system.

19. The method of claim 18, further comprising:
transmitting data from the Bluetooth LE beacon to the RFID tag across the data link; and
transmitting to the RFID reader system, by the RFID tag and in response to the interrogating operation by the RFID reader system, the data received from the Bluetooth LE beacon.

20. The method of claim 19, wherein the data includes one or more of battery status, temperature, or sensor data monitored by the Bluetooth LE beacon.
